(19) United States
(12) Patent Application Publication
(10) Pub. No.: US 2003/0224293 A1
(43) Pub. Date: Dec. 4, 2003

(54) Optical recording material

(75) Inventors: Keiji Oya, Saitama-Ken (JP); Atsurou Tomita, Saitama-Ken (JP); Toru Yano, Saitama-Ken (JP)

Correspondence Address: YOUNG & THOMPSON, 745 SOUTH 23RD STREET 2ND FLOOR, ARLINGTON, VA, 22202

(73) Assignee: ASAHI DENKA KOGYO KABUSHIKI KAISHA, TOKYO (JP)

(21) Appl. No.: 10/367,726

(22) Filed: Feb. 19, 2003

Related U.S. Application Data
(63) Continuation-in-part of application No. 09/630,610, filed on Aug. 2, 2000, now abandoned.

(30) Foreign Application Priority Data
Aug. 4, 1999 (JP) 11-221664

(51) Int. Cl. G11B 7/24

(52) U.S. Cl. 430/270.14; 430/270.2

(57) ABSTRACT

An optical recording medium comprising a substrate having formed thereon a thin film comprising an organic compound dye that can form pits when irradiated with a semiconductor laser beam and a compound represented by formula (I) as a recording layer:

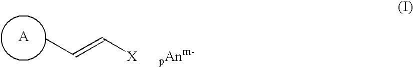

wherein X represents a metallocene group; ring A represents a specific heterocyclic ring with the metallocene group X bonded to the 2-position thereof; An^{m-} represents an m-valent anion; m represents 1 or 2; and p represents a coefficient for maintaining the charges neutral.

### BACKGROUND OF THE INVENTION

1. Field of the Invention

The present invention relates to an optical recording material used in an optical recording medium on which information is recorded by giving a thermal information pattern by a laser, etc. and to an optical recording medium comprising the material. More particularly, it relates to an optical recording material used in an optical recording medium capable of high-density optical recording and reproduction with a laser beam and the like of low energy having a wavelength in the visible and infrared regions and to an optical recording medium comprising the material.

2. Description of the Related Art

Optical recording media are generally characterized by freedom from wear because of non-contact with a writing or reading head. In particular they have a merit that information is given in the form of thermal information so that development processing in a dark room is unnecessary. For these advantages optical recording media have shown great development.

Such an optical recording medium utilizes recording light as heat. For example, it comprises a substrate having formed thereon a thin recording layer, on which optically detectable pits are formed to store information at high density.

Information recording on the optical recording medium is achieved by scanning the surface of the recording layer with a condensed laser beam to form pits on the irradiated area of the recording layer where the laser energy has been absorbed. The information thus recorded on the recording medium can be read by detecting the pits with a reading light beam.

The above-mentioned optical recording media include CD-Rs meeting compact disc (CD) standards which are capable of writing and reading and reproducing with a near infrared semiconductor laser having a wavelength of 770 to 830 nm; DVDs (digital videodiscs) having such a vast capacity as can record an animation film that is achieved by increasing the recording density by using a red semiconductor laser having a shorter wavelength (620 to 690 nm) with a smaller beam diameter combined with a bit reduction technique, etc.; and DVD-Rs which meet the DVD standards and are capable of additional writing or recording. The recording layers used in these optical recording media usually comprise inorganic optical recording materials, such as a metal thin film (e.g., aluminum deposit film), a tellurium oxide thin film, a bismuth thin film, a chalcogenide-based amorphous glass film, and the like.

Difficult to make by coating methods, these thin films are formed by sputtering or vacuum evaporation, which requires complicated operation. In addition, the recording layer made of the inorganic materials have such disadvantages as a high reflectance for laser light, a high thermal conductivity, and a low laser light utilization efficiency.

It has been proposed to use an optical recording materials as a recording layer mainly comprising organic compound dyes capable of forming pits by a semiconductor laser in place of the inorganic materials. Usable dyes include azo dyes, phthalocyanine dyes, and cyanine dyes. Among them cyanine dyes composed of cyanine dye cations (e.g., indolenine, thiazole, imidazole, oxazole, quinoline or selenazole nucleus) and various anions are preferably used for their high sensitivity. Still preferred are indocyanine dyes having an indolenine nucleus because of their particularly high sensitivity.

However, when used as a sole optical recording material, the organic compound dyes tend to be unsatisfactory in pit-forming properties, pit controlling properties, and light stability. These problems have come to be important with the ever increasing capacity of recording media.

To overcome the above problems, use of various additives imparting functions for pit formation acceleration, pit control, light stability, and the like has been under study. For example, Japanese Patent Application Laid-Open Nos. 98887/95, 291366/98, and 86337/99 propose use of metallocene compounds or metal β-diketonates, and Japanese Patent Publication Nos. 34464/89 and 34465/89 teach use of complex compounds called quenchers. However, the additives proposed fail to achieve sufficient effects on the above-described problems but tend to impair the recording characteristics, such as sensitivity.

### SUMMARY OF THE INVENTION

An object of the present invention is to provide an optical recording material which is for use in the recording layer of an optical recording medium and exhibits improvement in pit-forming properties, pit-controlling properties, light stability and the like. Another object of the present invention is to provide an optical recording medium comprising the optical recording material.

As a result of extensive investigation, the inventors of the present invention have found that the above objects are accomplished by using a novel metallocene compound having an indolenine skeleton.

Having been made based on the above-mentioned finding, the present invention provides an optical recording material comprising a compound represented by formula (I):

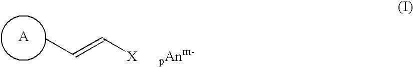

wherein X represents a metallocene group; ring A represents a heterocyclic ring selected from the group consisting of:

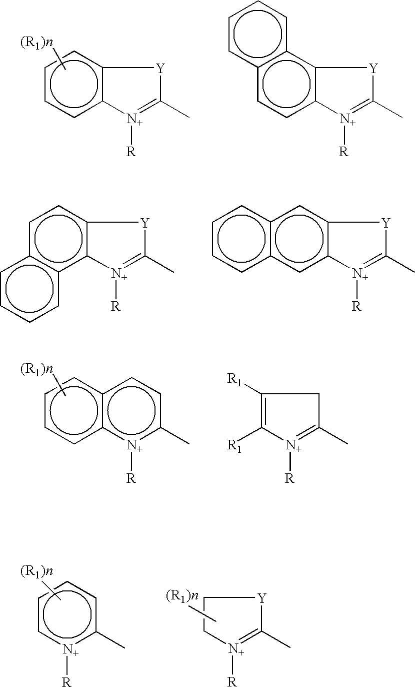

wherein n represents an integer of 0 to 2; R represents an organic group having 1 to 30 carbon atoms; R₁ represents a hydrogen atom, a halogen atom, a nitro group, a cyano group, an alkyl group having 1 to 4 carbon atoms, an alkoxy group having 1 to 4 carbon atoms, or an aryl group having 6 to 30 carbon atoms; Y represents an alkylidene group having 1 to 6 carbon atoms, a cycloalkylidene group having 3 to 6 carbon atoms, an oxygen atom, a sulfur atom, a selenium atom, or a nitrogen atom having an alkyl group having 1 to 8 carbon atoms, with the metallocene group X bonded to the 2-position thereof; An^{m-} represents an m-valent anion; m represents 1 or 2; and p represents a coefficient for maintaining the charges neutral.

The present invention also provides an optical recording medium comprising a substrate having formed thereon a thin film comprising the above-mentioned optical recording material as a recording layer.

The optical recording material of the present invention is excellent in pit-controlling properties, decomposition properties in a lower temperature and light stability. The optical recording medium according to the present invention is capable of high-density optical recording and reproduction with, e.g., a low-energy laser having a wavelength in the visible and infrared regions.

### DETAILED DESCRIPTION OF THE INVENTION

The compound represented by formula (I) which can be used as an optical recording material in the present invention is a novel compound, which serves as a function-imparting additive used in the recording layer of an optical recording medium hereinafter described.

In formula (I), the halogen atom as represented by R₁ in ring A includes fluorine, chlorine, bromine, and iodine. The alkyl group having 1 to 4 carbon atoms includes methyl, ethyl, propyl, isopropyl, butyl, isobutyl, sec-butyl, and t-butyl groups. The alkoxy group having 1 to 4 carbon atoms includes one derived from the alkyl group. The aryl group having 6 to 30 carbon atoms includes phenyl, naphthyl, benzyl, 4-methylphenyl, 4-vinylphenyl, 2-methylphenyl, 3-methylphenyl, 2,4-dimethylphenyl, 2,5-dimethylphenyl, 4-isopropylphenyl, 4-butylphenyl, 4-t-butylpehnyl, 4-hexylphenyl, 4-cyclohexylphenyl, 4-octylphenyl, and 4-(2-ethylhexyl)phenyl. The organic group having 1 to 30 carbon atoms as represented by R is not particularly limited and may have a branched structure, an unsaturated bond, an ether bond, an aryl group, etc. The organic group may contain a substituent(s), such as a halogen atom, a cyano group, a nitro group, etc. The alkylidene group having 1 to 6 carbon atoms as represented by Y includes methylidene, dimethylmethylidene, ethylrnethylmethylidene, diethylmethylidene, methylpropylmethylidene, and ethylpropylmethylidene groups. The cycloalkylidene group having 3 to 6 carbon atoms includes cyclopropane-1,1-diyl, cyclobutane-1,1-diyl, 2,4-dimethylcyclobutane-1,1-diyl, 3-dimethylcyclobutane-1,1-diyl, cyclopentane-1,1-diyl, and cyclohexane-1,1-diyl groups. The alkyl group having 1 to 8 carbon atoms which is bonded to the nitrogen atom as Y includes methyl, ethyl, propyl, isopropyl, butyl, sec-butyl, t-butyl, isobutyl, amyl, t-amyl, hexyl, heptyl, octyl, isooctyl, t-octyl, and 2-ethylhexyl groups.

The anion as represented by An^{m-} includes, but is not limited to, halide anions such as chloride anion, bromide anion, iodide anion and fluoride anion; inorganic anions such as perchloate anion, chlorate anion, thiocyanate anion, hexafluorophosphate anion, hexafluoroantimonate anion and tetrafluoroborate anion; organic sulfonate anions such as benzenesulfonate anion, toluenesulfonate anion, trifluoromethanesulfonate anion and diphenylamine-4-sulfonate anion; organic phosphate anions such as octylphosphate anion, dodecylphosphate anion, octadecylphosphate anion, phenylphosphate anion, nonylphenylphosphate anion, and 2,2′-methylenebis(4,6-di-t-butylphenyl)phosphonate anion; and anions of so-called quenchers described later. Divalent anions include a benzenedisulfonate anion and a naphthalenedisulfonate anion.

In formula (I), the metallocene group X is a group derived from generally known metallocene compounds and includes, but is not limited to, the following groups.

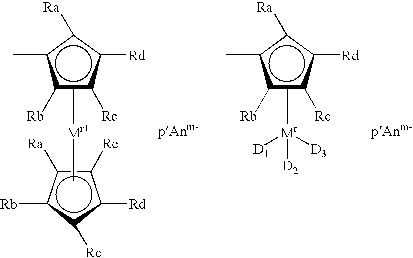

wherein Rₐ, R_{b}, R_{c}, R_{d}, and Rₑ each represent a hydrogen atom or an alkyl group having 1 to 4 carbon atoms; M represents a metal atom; D₁, D₂, and D₃ each represent a halogen atom, an alkyl group having 1 to 4 carbon atoms or an alkylcyclopentadienyl group; An^{m-} represents an m-valent anion, which may be the same as or different from the An^{m-} in formula (I); r represents 0 or 1; m represents 1 or 2; and p′ represents a coefficient for maintaining the charges neutral.

The alkyl group having 1 to 4 carbon atoms as represented by Rₐ, R_{b}, R_{c}, R_{d}, and Rₑ includes methyl, ethyl, propyl, isopropyl, butyl, isobutyl, sec-butyl, and t-butyl groups. The metal atom M includes titanium, zirconium, vanadiun, niobium, tantalum, chromium, molybdenum, tungsten, manganese, iron, ruthenium, cobalt, nickel, copper, zinc, aluminum, gallium, indium, silicon, germanium, tin, antimony, bismuth, gold, silver, palladium, rhodiun, platinum, iridium, yttrium, lanthanum, praseodymium, neodymium, promethium, gadolinium, dysprosium, and holmium. The halogen atom as represented by D₁, D₂, and D₃ includes fluorine, chlorine, bromine, and iodine The allyl group having 1 to 4 carbon atoms includes methyl, ethyl, propyl, isopropyl, butyl, isobutyl, sec-butyl, and t-butyl groups. The alkylcyclopentadienyl group includes a cyclopentadienyl group substituted with Rₐ, R_{b}, R_{c}, R_{d}, and Rₑ. The anion An^{m-} includes the same mono- or divalent anions as enumerated for that in formula (I).

Of the two metallocene groups shown above the left one is preferred because of easy availability and excellent pit-forming properties of the compound.

Of the compounds represented by (I), ferrocene compounds represented by formula (II) are preferred from the standpoint of cost and performance.

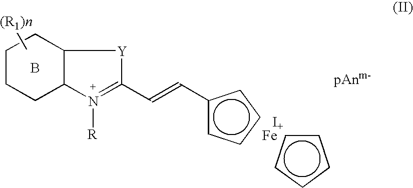

wherein ring B represents a benzene ring or a naphthalene ring; R represents an organic group having 1 to 30 carbon atoms; R₁ represents a hydrogen atom, a halogen atom, a nitro group, a cyano group, an alkyl group having 1 to 4 carbon atoms, or an alkoxy group having 1 to 4 carbon atoms; n represents an integer of 0 to 2 when ring B is a benzene ring, or n represents 0 when ring B is a naphthalene ring; Y represents an alkylidene group having 1 to 6 carbon atoms, a cycloalkylidene group having 3 to 6 carbon atoms, an oxygen atom, a sulfur atom, a selenium atom, or a nitrogen atom having an alkyl group having 1 to 8 carbon atoms; 1 represents the valence of the ferrocene group, being 0 or 1; An^{m-} represents an m-valent anion; m represents 1 or 2; and p represents a coefficient for maintaining the charges neutral.

Examples of R₁, R, Y, and An^{m-} in formula (II) are the same as those described as for (I).

Specific examples of the compounds represented by formula (II) include the following compound Nos. 1 to 8, in which only cations are shown.

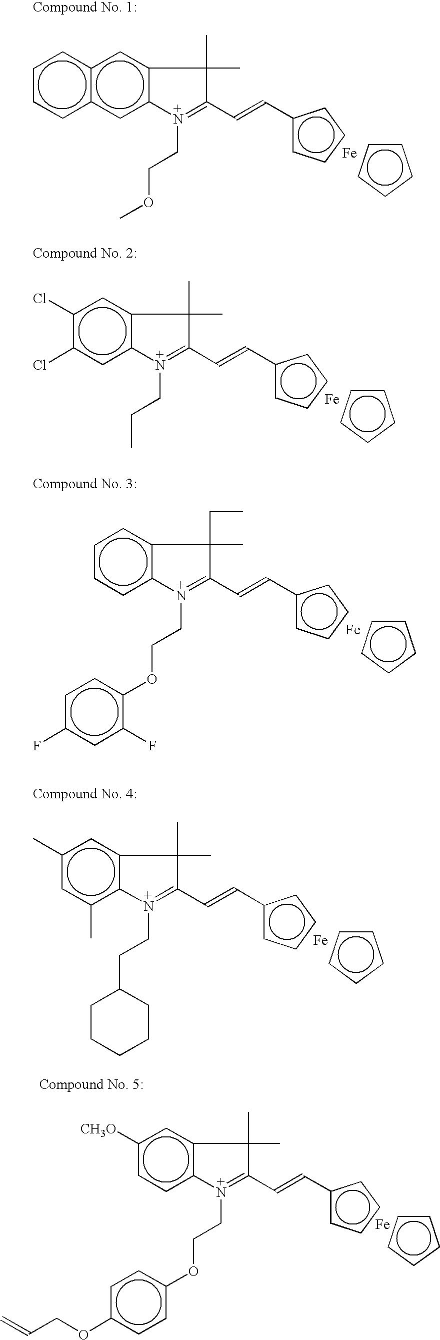

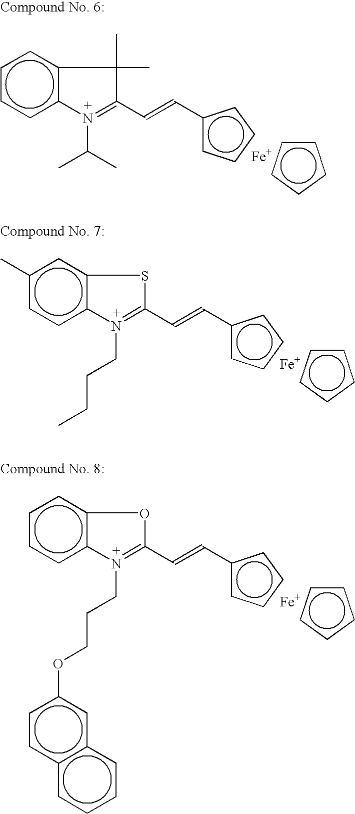

Still preferred of the ferrocene compounds represented by formulae (I) and (II) are those in which Y is an alkylidene group having 1 to 6 carbon atoms or a cycloalkylidene group having 3 to 6 carbon atoms, and R is an organic group having formula (III):

R₃—(O)_{q}—R₂— (III)

wherein q represents 0 or 1; R₂ represents an alkylene group having 1 to 4 carbon atoms; and R₃ represents a hydrogen atom, an alkyl group having 1 to 4 carbon atoms, an alkenyl group having 2 to 4 carbon atoms, a phenyl group, or a phenyl group having one or two substituents selected from a halogen atom, an alkyl group having 1 to 4 carbon atoms, and an alkoxy group having 1 to 4 carbon atoms.

In formula (III), the alkylene group having 1 to 4 carbon atoms as represented by R₂ includes methylene, ethylene, propylene, 1-methylethylene, 2-methylethylene, and butylene. The alkyl group having 1 to 4 carbon atoms as represented by R₃ includes those enumerated as for R₁ in formulae (I) and (II). The alkenyl group having 2 to 4 carbon atoms as represented by R₃ includes vinyl, propenyl, isopropenyl, and butenyl. The halogen atom as a substitute on the phenyl group as R₃ includes fluorine, chlorine, bromine, and iodine. The alkyl or alkoxy group having 1 to 4 carbon atoms as a substituent on the phenyl group as R₃ includes those described as for R₁ of formulae (I) and (II).

Specific examples of the above-described still preferred compounds are compound Nos. 9 to 14 shown below, in which only cations are shown omitting anions.

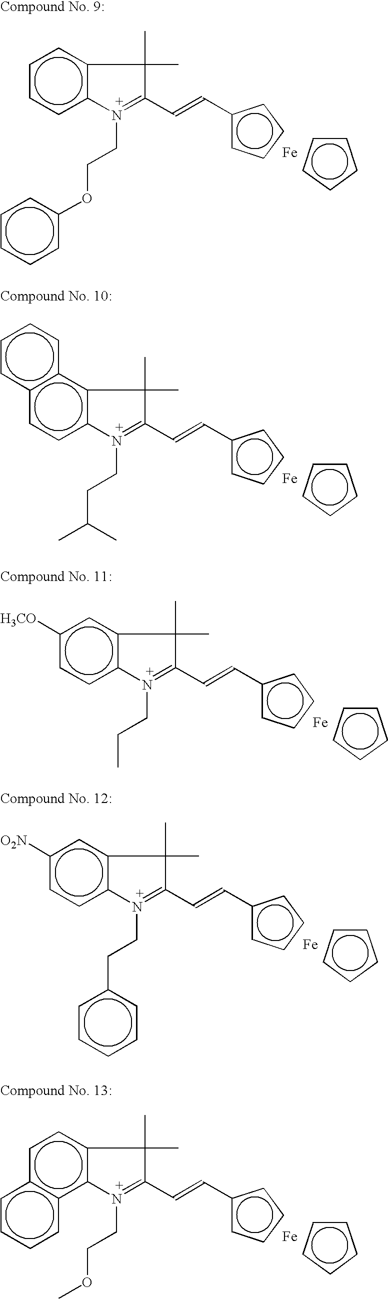

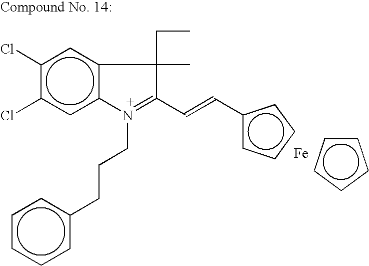

While not limiting, the above-described preferred ferrocene compounds can be synthesized through the following reaction route:

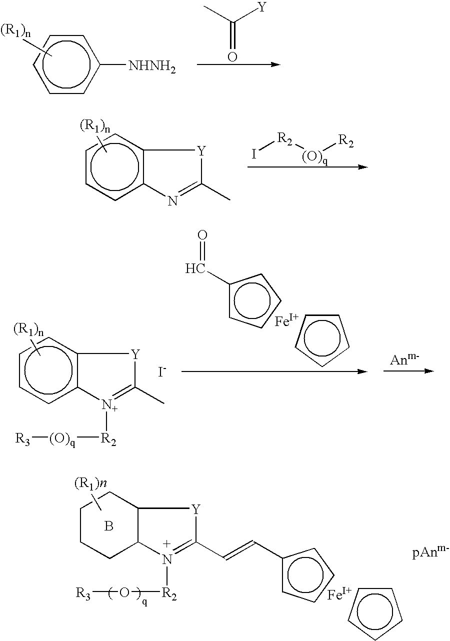

wherein R₁, R₂, R₃, An^{m-}, l, m, n, p, and q are as defined above in formulae (II) and (III); and Y represents an alkylidene group having 1 to 6 carbon atoms or a cycloalkylidene group having 3 to 6 carbon atoms.

The novel metallocene compounds of the present invention represented by formula (I) possess the following characteristics and are excellent as a function-imparting additive for an optical recording material.

(1) They function as a light stabilizer. That is, they prevent fading of dyes due to natural light, imparting light resistance to a recording material.

(2) They function as a pit-formation accelerator. That is, they are effective in lowering the pit-forming temperature of a dye layer.

(3) They function as a pit controlling agent. That is, they provide a definite threshold temperature for pit formation, enabling formation of sharp pits.

(4) They are not volatile. Absence of volatility secures safety in forming a recording layer and quality stability of the recording layer.

The optical recording material according to the present invention usually comprises a dye. The dye to be used is not particularly limited as long as it is an organic compound that can form pits when irradiated with a semiconductor laser beam. Any of known organic compound dyes, such as azo dyes, phthalocyanine dyes, and cyanine dyes, can be used. Cyanine dyes are preferred. Indocyanine dyes are particularly advantageous in that the compounds of the present invention manifest excellent effects of addition on the indocyanine dyes.

The following compound Nos. 15 to 27 are suitable examples of the indocyanine dye, in which only cations are shown omitting anions.

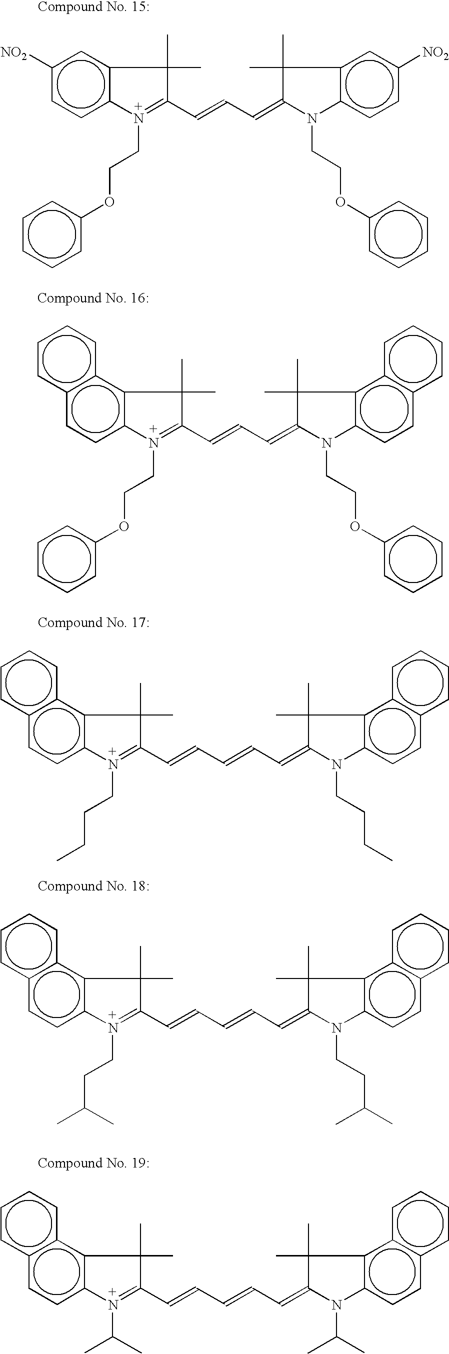

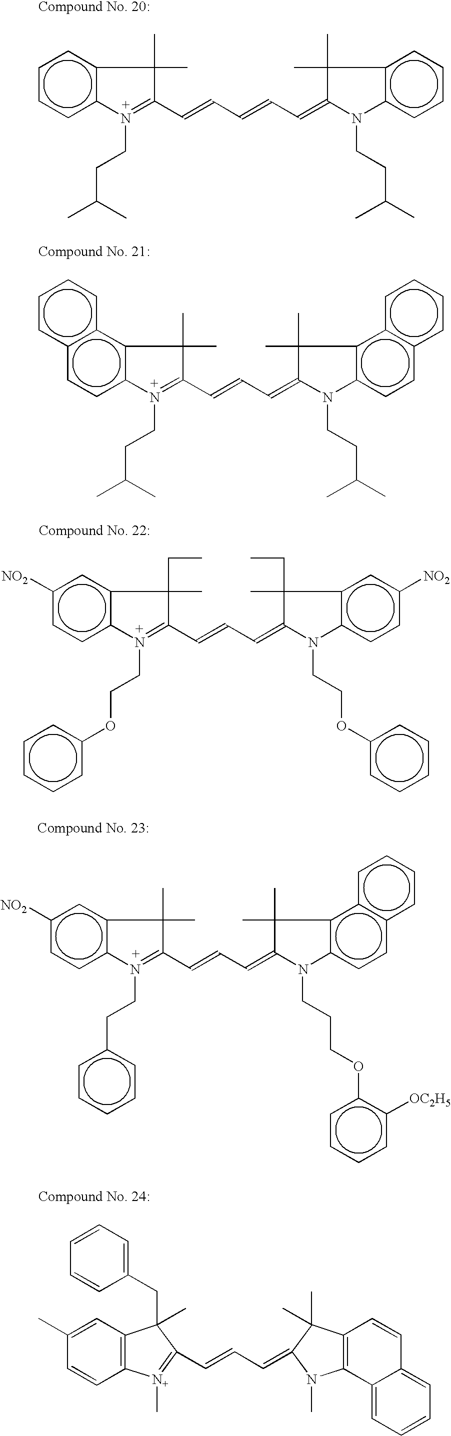

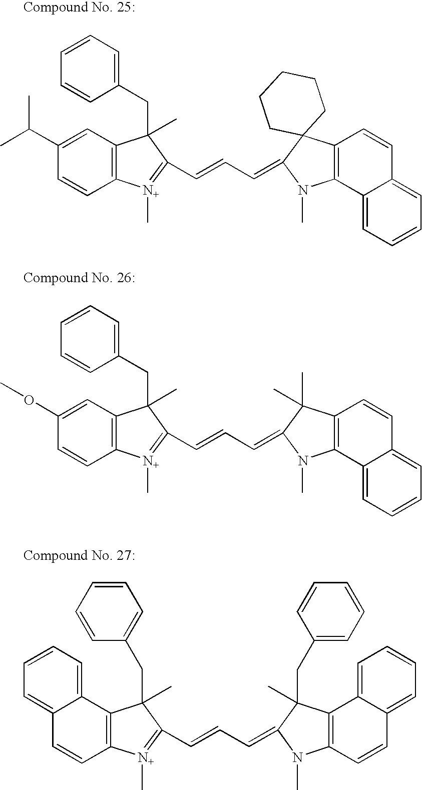

The optical recording material of the present invention essentially comprises the metallocene compound of formula (I). It preferably comprises both the metallocene compound (I) and the dye. The optical recording material is applied as a recording layer of optical recording media such as LDs, CDs, DVDs, CD-Rs, and DVD-Rs.

In the present invention, the metallocene compound is preferably used in an amount of 0.01% by weight or more based on the dye. When used in less amounts than 0.01% by weight, the metallocene compound hardly produces substantial effects of addition. In particular, it is preferably used in an amount of 0.1 to 20% by weight based on the dye for use as a recording layer of CD-Rs or DVD-Rs.

The optical recording medium according to the present invention comprises a substrate having formed thereon a thin film comprising the aforementioned optical recording material as a recording layer.

The recording layer of the optical recording medium can be formed by methods well-known in the art. In general, the recording layer is formed easily by applying to a substrate a solution of the optical recording material in an organic solvent. Useful organic solvents include lower alcohols, such as methanol and ethanol; ether alcohols, such as methyl cellosolve, ethyl cellosolve, butyl cellosolve, and butyl diglycol; ketones, such as acetone, methyl ethyl ketone, methyl isobutyl ketone, cyclohexanone, and diacetone alcohol; esters, such as ethyl acetate, butyl acetate, and methoxyethyl acetate; acrylic esters, such as ethyl acrylate and butyl acrylate; fluorinated alcohols, such as 2,2,3,3-tetrafluoropropanol; hydrocarbons, such as benzene, toluene, and xylene; and chlorinated hydrocarbons, such as methylene dichloride, dichloroethane, and chloroform.

The recording layer usually has a thickness of 0.001 to 10 μm, preferably 0.01 to 5 μm. The method of applying the optical recording material solution is not particularly restricted and includes, for example, spin coating.

The recording layer of the optical recording medium of the present invention preferably comprises the metallocene compound and the dye in a total proportion of 50 to 100% by weight.

If desired, the recording layer of the optical recording medium of the present invention can further comprise resins, such as polyethylene, polyester, polystyrene, and polycarbonate, in addition to the above-described optical recording material. It can further comprise other additives, such as surface active agents, antistatic agents, lubricants, flame retardants, light stabilizers, dispersants, antioxidants, crosslinking agents, and so forth.

The recording layer can furthermore comprise aromatic nitroso compounds, bisiminium compounds, transition metal chelate compounds, etc. as a quencher for single stage oxygen, etc. The compounds useful as the quencher are described, e.g., in Japanese Patent Application Laid-Open Nos. 55795/84 and 234892/85. These compounds are preferably used in an amount of up to 50% by weight based on the recording layer.

The compounds useful as a quencher typically include those represented by formulae (A) to (I) shown below.

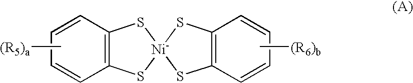

wherein R₅ and R₆ each represent an alkyl group or a halogen atom; and a and b each represent an integer of 0 to 4.

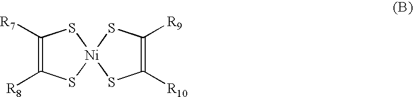

wherein R₇, R₈, R₉, and R₁₀ each represent a phenyl group, a cyclohexyl group, or a phenyl or a cyclohexyl group substituted with one to four substituents selected from an alkyl group, an alkenyl group, an alkoxy group, a monoalkylamino group, a dialkylamino group, and a halogen atom.

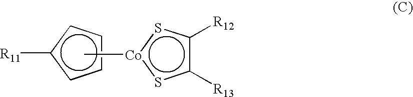

wherein R₁₁ represents a hydrogen atom, an alkyl group or an alkoxy group; R₁₂ and R₁₃ each represent a hydrogen atom, a hydroxyl group, a nitro group, a halogen atom, a cyano group, an alkyl group, a phenyl group, a carboxyl group or an alkoxycarbonyl group.

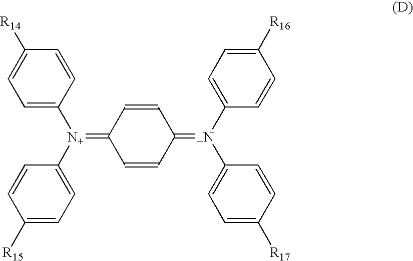

wherein R₁₄, R₁₅, R₁₆, and R₁₇ each represent the same group as R₁₂, a monoalkylamino group or a dialkylamino group.

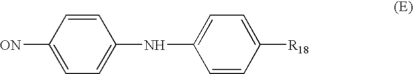

wherein R₁₈ has the same meaning as R₁₄.

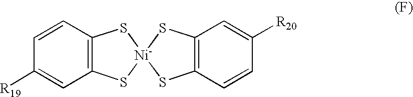

wherein R₁₉ and R₂₀ each have the same meaning as R₅.

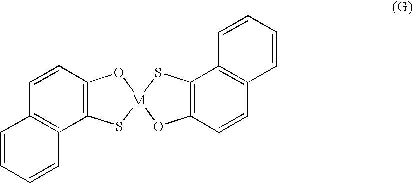

wherein M represents Ni or Co.

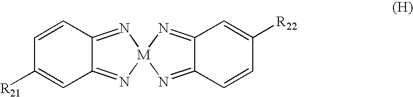

wherein M represents Ni or Fe; and R₂₁ and R₂₂ each have the same meaning as R₅.

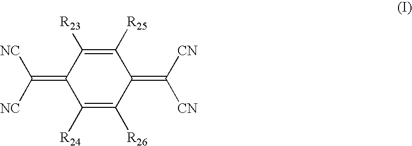

wherein R₂₃, R₂₄, R₂₅, and R₂₆ each represent a hydrogen atom, a halogen atom, an alkyl group or an alkenyl group; a set of R₂₃ and R₂₅ or a set of R₂₄ and R₂₆ may be connected to each other to form an unsaturated condensed ring.

The substrate on which the recording layer is to be provided is not particularly restricted as far as it is substantially transparent to writing or reading light. Useful materials for the substrate include resins, such as polymethyl methacrylate, polyethylene terephthalate, and polycarbonate, and glass. The shape of the substrate is arbitrarily selected from a tape, a drum, a belt, a disc, and the like.

The recording layer may have a reflective coat of gold, silver, aluminum, copper, etc. formed by vacuum evaporation or sputtering or a protective coat of an acrylic resin, an ultraviolet-curing resin, etc.

The optical recording medium according to the present invention includes optical discs, such as LDs, CDs, DVDs, CD-Rs, and DVD-Rs.

The present invention will now be illustrated in greater detail with reference to Preparation Examples, Examples, and Comparative Examples, but it should be understood that the invention is not construed as being limited thereto. Unless otherwise noted, all the percents and parts are by weight.

### PREPARATION EXAMPLE 1

### Prepartion of Compound No. 9 (hexfluorophosphate)

In a reaction flask were charged 35.4 g of benzenesulfonyl chloride, 33.2 g of 2-phenoxyethanol, and 222.4 g of toluene, and 40.4 g of triethylamine was added thereto dropwise under cooling with ice over a period of 1 hour. The mixture was allowed to react under cooling for 1 hour and then at room temperature for an additional 1 hour period. The reaction mixture was washed with water and dried over anhydrous sodium sulfate, and the solvent was removed. Recrystallization of the residual crude crystals from 55.6 g of ethanol gave 47.2 g (85% by yield) of phenoxyethyl benzenesulfonate.

In a reaction flask were put 23.9 g of 2,3,3-trirethylindolenine, 41.7 g of the phenoxyethyl benzenesulfonate prepared above, and 131.2 g of 1-butanol, and the mixture was allowed to react at 120° C. for 3 hours, followed by cooling, filtration, and washing with ethanol to give 53.8 g (82% by yield) of crystals of compound No. 9 in the form of a benzenesulfonate.

In a reaction flask were put 4.4 g of the resulting benzenesulfonate, 2.1 g of ferrocenecarboxyaldehyde, and 6.2 g of dimethylformamide, and the mixture was allowed to react for 1 hour. To the reaction mixture were added 3.7 g of potassium hexafluorophosphate and 12.4 g of dimethylformamide to cause salt exchange at 80° C. for 1 hour. The reaction mixture was extracted with 20 g of chloroform, and the extract was washed with water and dried over anhydrous sodium sulfate. After solvent removal, the residual crude crystals were purified by silica gel column chromatography using a 3/7 (by volume) mixed solvent of hexane/ethyl acetate to yield 1.2 g (20% by yield) of the title compound.

Results of analysis:

UV Absorption spectrum: λₘₐₓ 640 nm (ε=1.1×10⁴)

PMR Absorption spectrum (ppm; multiplicity; H)

(1.8; s; 6), (4.4; s; 5), (4.5; t; 2), (4.8; t; 2), (5.0; s; 2),

(5.1; s; 2), (6.7; d; 2), (6.9; t; 1), (7.0; d; 1), (7.2; t; 2), (7.4-7.6; m; 3)

(7.6; d; 1), and (8.3; d; 1)

Mass spectrum: 621 (calcd.=621.3)

Elemental analysis:

Found (%): C 58.0; H 4.81; N 2.14

Calcd. (%): C 58.0; H 4.87; N 2.25

Fe Analysis: 8.88% (calcd.=8.99%)

### PREPARATION EXAMPLE 2

### Preparation of Compound No. 10 (iodide)

In a reaction flask were charged 31.6 g of β-naphthylhydrazine and 48.0 g of acetic acid, and the mixture was heated up to 80° C., to which 20.7 g of 3-methyl-2-butanone was added dropwise. The mixture was allowed to react at 100° C. for 2 hours. After acetic acid was removed, the residue was extracted with 167.4 g of toluene. The extract was washed successively with a 20% aqueous solution of sodium hydroxide and water and dried over anhydrous sodium sulfate. The solvent was removed, and the residual crude crystals were recrystallized from toluene to afford 23.4 g (56% by yield) of 2,3,3-trimethylbenzoindolenine.

In a reaction flask were charged 20.9 g of the resulting 2,3,3-trimethylbenzoindolenine and 39.6 g of isoamyl iodide and allowed to react at 120° C. for 3 hours. To the reaction mixture was added 20.4 g of ethyl acetate at 80° C. to crystallize 1-isoamyl-2,3,3-trimethylbenzoindolenine iodide in a yield of 31.3 g (77% by yield).

In a reaction flask were put 4.1 g of the resulting iodide, 2.1 g of ferrocenecarboxyaldehyde, and 6.0 g of dimethylformamide, and the mixture was allowed to react for 1 hour. The resulting crude crystals were purified by silica gel column chromatography using a 3/7 (by volume) mixed solvent of hexane/ethyl acetate to give 0.7 g (12% by yield) of the title compound.

Results of analysis:

UV Absorption spectrum: λₘₐₓ 637 nm (ε=1.0 ×10⁴)

PMR Absorption spectrum (ppm; multiplicity; H):

(1.1; d; 6), (1.8-1.9; m; 3), (1.9; s; 6), (4.4; s; 5), (4.8; t; 2), (5.0; s; 2),

(5.3; s; 2), (7.2; d, 1), (7.6-7.7; m; 3), (8.0-8.1; m; 3), and (8.6; d; 1)

Mass spectrum: 603 (calcd.=603.4)

Elemental analysis:

Found (%): C 61.4; H 5.61; N 2.35

Calcd. (%): C 61.7; H 5.68; N 2.32

Fe Analysis: 9.30% (calcd.=9.25%)

### PREPARATION EXAMPLE 3

### Synthesis of Compound No. 11 (perchlorate)

In a reaction flask were charged 27.6 g of 4-methoxyphenylhydrazine and 48.0 g of acetic acid, and the temperature was raised to 80° C., at which 20.7 g of 3-methyl-2-butanone was added dropwise. The reaction mixture was allowed to react at 100° C. for 2 hours. The acetic acid was removed, and the residue was extracted with 151.2 g of toluene. The extract was washed successively with a 20% aqueous solution of sodium hydroxide and water and dried over anhydrous sodium sulfate. The solvent was removed to afford 22.6 g (60% by yield) of 2,3,3-trimethyl-5-methoxyindolenine.

In a reaction flask were charged 18.9 g of the resulting 2,3,3-trimethyl-5-methoxyindolenine and 33.8 g of propyl iodide and allowed to react at 100° C. for 3 hours. To the reaction mixture was added 18.0 g of ethyl acetate at 80° C. for crystallization to yield 26.6 g (74% by yield) of crystals of 1-propyl-2,3,3-trimethyl-5-methoxyindolenine iodide.

In a reaction flask were put 3.6 g of the resulting iodide, 2.1 g of ferrocenecarboxyaldehyde, and 5.3 g of dimethylformamide, and the mixture was allowed to react for 1 hour. To the reaction mixture was added a solution of 2.8 g of sodium perchlorate monohydrate in 11.2 g of methanol to conduct salt exchange at 70° C. for 1 hour. The reaction mixture was extracted with 20 g of chloroform, and the extract was washed with water and dried over anhydrous sodium sulfate. After solvent removal, the resulting crude crystals were purified by silica gel column chromatography using a 3/7 (by volume) mixed solvent of hexane/ethyl acetate to afford 0.8 g (15% by yield) of the title compound.

Results of analysis:

UV Absorption spectrum: λₘₐₓ 625 nm (ε=0.93×10⁴)

PMR Absorption spectrum (ppm; multiplicity; H):

(1.0; t; 3), (1.9; s; 6), (2.0; m; 2), (3.9; s; 3), (4.3; s; 5), (4.4; t; 2), (5.0; s; 2),

(5.1; s; 2), (6.9; d; 1), (7.0; m; 2), (7.5; d; 1), and (8.2; d; 1)

Mass spectrum: 527 (calcd.=527.8)

Elemental analysis:

Found (%): C 58.9; H 5.69; N 2.66

Calcd. (%): C 59.2; H 5.73; N 2.65

Fe Analysis: 10.3% (calcd.=10.6%)

### PREPARATION EXAMPLE 4

### Synthesis of Compound No. 12 (tetrafluoroborate)

In a reaction flask were charged 153.1 g of 4-nitrophenylhydrazine and 600 g of acetic acid and heated to 80° C., and 103.3 g of 3-methyl-2-butanone was added thereto dropwise, followed by stirring at that temperature for 1 hour. To the reaction mixture was added dropwise 196.1 g of sulfuric acid at the same temperature, and the mixture was allowed to react at 108° C. for 2 hours. After cooling, 816.8 g of toluene was added thereto, and the reaction mixture was washed successively with a 20% aqueous solution of sodium hydroxide and water and dried over anhydrous sodium sulfate. After solvent removal, the resulting crude crystals were recrystallized from 204.2 g of ethanol to give 61.2 g (30% by yield) of 2,3,3-trimethyl-5-nitroindolenine crystals.

Separately, 176.6 g of benzenesulfonyl chloride, 146.6 g of 2-phenethylethanol, and 1049.3 g of toluene were put in a reaction flask, and 202.4 g of triethylamine was added thereto dropwise over 1 hour while cooling with ice. The mixture was allowed to react under cooling for 1 hour and then at room temperature for an additional 1 hour period. The reaction mixture was again cooled in an ice bath and washed successively with a 35% hydrochloric acid aqueous solution and water and dried over anhydrous sodium sulfate. The solvent was removed to yield 212.5 g (81% by yield) of phenethyl benzenesulfonate.

In a reaction flask were charged 20.4 g of 2,3,3-trimethyl-5-nitroindolenine and 52.4 g of phenethyl benzenesulfonate and allowed to react at 130° C. for 1 hour. To the reaction mixture was added 23.3 g of ethyl acetate at 80° C. to cause crystallization to obtain 19.6 g (42% by yield) of 1-phenethyl-2,3,3-trimethyl-5-nitroindoleninebcnzenesulfonate.

In a reaction flask were put 4.7 g of the resulting sulfonate, 2.1 g of ferrocenecarboxyaldehyde, and 5.3 g of dimnethylformamide and allowed to react for 1 hour. To the reaction mixture were added 2.2 g of sodium tetrafluoroborate and 10.6 g of dimethylformamide to carry out salt exchange at 80° C. The reaction mixture was extracted with 20 g of chloroform, and the extract was washed with water and dried over anhydrous sodium sulfate. After solvent removal, the resulting crude crystals were purified by silica gel column chromatography using a 3/7 (by volume) mixed solvent of hexane/ethyl acetate to furnish 1.1 g (19% by yield) of the title compound.

Results of analysis:

UV Absorption spectrum: ) λₘₐₓ 675 nm (ε=1.0×10⁴)

PMR Absorption spectrum (ppm; multiplicity; H):

(1.7; s; 6), (2.4; t; 2), (4.3; s; 5), (4.5; t; 2), (5.0; s; 2), (5.2; s; 2), (6.7; d; 1),

(7.1-7.2; m; 5), (7.8; d; 1), (8.4; d; 1), (8.5; s; 1), and (8.6; d; 1)

Mass spectrum: 592 (calcd.=592.2)

Elemental analysis:

Found (%): C 60.4; H 4.89; N 4.69

Calcd. (%): C 60.8; H 4.94; N 4.73)

Fe Analysis: 9.38% (calcd.=9.43%)

### PREPARATION EXAMPLE 5

### Synthesis of Compound No. 14 (iodide)

In a reaction flask were put 213.5 g of 3,4-dichlorophenylhydrazine hydrochloride and 240.2 g of acetic acid, and the mixture was heated up to 80° C. To the reaction mixture, 120.2 g of 3-methyl-2-pentanone was added dropwise, and the mixture was allowed to react at 100° C. for 2 hours. After acetic acid was removed, the residue was extracted with 968.6 g of toluene. The extract was washed with water and dried over anhydrous sodium sulfate. The solvent was removed, and the residual crude crystals were purified by silica gel column chromatography using a 3/7 (by volume) mixed solvent of hexane/ethyl acetate to give 60.8 g (25% by yield) of 3-ethyl-2,3-dimethyl-4,5-dichloroindolenine.

In a reaction flask were charged 24.2 g of the resulting 3-ethyl-2,3-dimethyl-4,5-dichloroindolenine and 49.2 g of 3-phenylpropyl iodide and allowed to react at 130° C. for 2 hours. To the reaction mixture was added 47.4 g of ethyl acetate at 80° C. to crystallize 1-phenylpropyl-2,3,3-trimethyl-4,5-dichloroindolenine iodide in a yield of 22.3 g (47% by yield).

In a reaction flask were put 4.7 g of the resulting iodide, 2.1 g of ferrocenecarboxyaldehyde, and 6.7 g of dimethylformamide, and the mixture was allowed to react for 1 hour, followed by extraction with 20 g of chloroform. The extract was washed with water and dried over anhydrous sodium sulfate. The solvent was removed, and the resulting crude crystals were purified by silica gel column chromatography using a 3/7 (by volume) mixed solvent of hexane/ethyl acetate to furnish 1.1 g (16% by yield) of the title compound.

Results of analysis:

UV Absorption spectrum: λₘₐₓ 660 nm (ε=0.97×10⁴)

PMR Absorption spectrum (ppm; multiplicity; H):

(1.0; t; 3), (1.6; m; 2), (1.7; s; 3), (1.9; q; 2), (2.6; t;2), (4.3; s; 5), (4.4; t; 2),

(5.2; s; 2), (5.3; s; 2), (6.8; d; 1), (7.1-7.0; m; 5), (8.2; s; 1), (8.4; s; 1), and

(8.5; d; 1)

Mass spectrum: 683 (calcd.=683.1)

Elemental analysis:

Found (%): C 55.8; H 4.77; N 2.00

Calcd. (%): C 56.2; H 4.71; N 2.05

Fe Analysis: 8.10% (calcd.=8.16%)

### Examples 1 to 3 and Comparative Examples 1 to 3 Evaluation of Thermal Behavior:

The thermal behavior of the ferrocene compounds mixed with the dye shown in Tables 1 to 3 was observed by differential thermal analysis. A mixture of the ferrocene compound and the dye, being to decompose by heat to form pits, which decomposes in a narrower temperature range to show a sharper decomposition behavior has more excellent pit controlling properties, and one which decomposes in a lower temperature is more advantageous from the standpoint of energy consumption. Accordingly, the pit controlling properties were evaluated from the decomposition staring temperature (Ts) in thermogravimetry (TG) and the decomposition peak top temperature (Tt) in differential scanning calorimetry (DSC) and the peak shape, and reduction in decomposition temperature was evaluated from the peak top temperature in DSC. The results obtained are shown in Tables 1 to 3.

TABLE 1

| | Dye | Ferrocene Cpd. | Anion | Tt | Tt-Ts | Peak |
|---|---|---|---|---|---|---|
| | (part) | (part) | Species^{*1} | (° C.) | (° C.) | Shape^{*3} |
| Example 1 | No. 17 | No. 9 | PF₆⁻ | 244.6 | 10.2 | 4 |
| | (98) | (2) | | | | |
| | No. 17 | No. 9 | PF₆⁻ | 229.1 | 5.8 | 5 |
| | (95) | (5) | | | | |
| | No. 17 | No. 9 | PF₆⁻ | 221.7 | 4.9 | 5 |
| | (90) | (10) | | | | |
| | No. 17 | No. 10 | PF₆⁻ | 246.2 | 10.5 | 4 |
| | (98) | (2) | | | | |
| | No. 17 | No. 10 | PF₆⁻ | 231.4 | 6.2 | 4 |
| | (95) | (5) | | | | |
| | No. 17 | No. 10 | PF₆⁻ | 227.4 | 5.6 | 5 |
| | (90) | (10) | | | | |
| | No. 17 | No. 12 | PF₆⁻ | 228.6 | 9.9 | 4 |
| | (98) | (2) | | | | |
| | No. 17 | No. 12 | PF₆⁻ | 223.1 | 4.9 | 5 |
| | (95) | (5) | | | | |
| | No. 17 | No. 12 | PF₆⁻ | 221.4 | 4.7 | 5 |
| | (90) | (10) | | | | |
| Compa. | No. 17 | — | PF₆⁻ | 259.4 | 11.7 | 3 |
| Example 1 | (100) | | | | | |
| | No. 17 | (A)^{*2} | PF₆⁻ | 210.1 | 26.4 | 1 |
| | (98) | (2) | | | | |
| | No. 17 | (A) | PF₆⁻ | 202.4 | 32.1 | 1 |
| | (95) | (5) | | | | |
| | No. 17 | (A) | PF₆⁻ | 199.3 | 32.4 | 1 |
| | (90) | (10) | | | | |

Note:
^{*1}The anion species is common to the dye and the ferrocene compound (hereinafter the same).
^{*2}Comparative compound (A) of formula:
^{*3}The peak shape was rated from 1 to 5. The higher the rate, the sharper the peak.

TABLE 2

| | Dye | Ferrocene Cpd. | Anion | Tt | Tt-Ts | Peak |
|---|---|---|---|---|---|---|
| | (part) | (part) | Species | (° C.) | (° C.) | Shape |
| Example 2 | No. 15 | No. 9 | PF₆⁻ | 258.2 | 10.8 | 4 |
| | (98) | (2) | | | | |
| | No. 15 | No. 9 | PF₆⁻ | 241.2 | 7.6 | 5 |
| | (95) | (5) | | | | |
| | No. 15 | No. 9 | PF₆⁻ | 239.4 | 3.8 | 5 |
| | (90) | (10) | | | | |
| | No. 15 | No. 10 | PF₆⁻ | 262.1 | 10.7 | 4 |
| | (98) | (2) | | | | |
| | No. 15 | No. 10 | PF₆⁻ | 242.4 | 8.4 | 4 |
| | (95) | (5) | | | | |
| | No. 15 | No. 10 | PF₆⁻ | 240.0 | 3.8 | 5 |
| | (90) | (10) | | | | |
| | No. 15 | No. 12 | PF₆⁻ | 259.8 | 9.9 | 4 |
| | (98) | (2) | | | | |
| | No. 15 | No. 12 | PF₆⁻ | 241.1 | 5.6 | 5 |
| | (95) | (5) | | | | |
| | No. 15 | No. 12 | PF₆⁻ | 240.3 | 3.3 | 5 |
| | (90) | (10) | | | | |
| Compa. | No. 15 | — | PF₆⁻ | 274.2 | 12.2 | 3 |
| Example 2 | (100) | | | | | |
| | No. 15 | (A) | PF₆⁻ | 225.9 | 33.9 | 1 |
| | (98) | (2) | | | | |
| | No. 15 | (A) | PF₆⁻ | 215.4 | 35.3 | 1 |
| | (95) | (5) | | | | |
| | No. 15 | (A) | PF₆⁻ | 212.1 | 35.4 | 1 |
| | (90) | (10) | | | | |

TABLE 3

| | Dye | Ferrocene Cpd. | Anion | Tt | Tt-Ts | Peak |
|---|---|---|---|---|---|---|
| | (part) | (part) | Species | (° C.) | (° C.) | Shape |
| Example 3 | No. 18 | No. 9 | ClO₄⁻ | 228.0 | 4.7 | 5 |
| | (95) | (5) | | | | |
| | No. 21 | No. 9 | Γ | 233.4 | 4.2 | 5 |
| | (95) | (5) | | | | |
| | No. 22 | No. 9 | BF₄⁻ | 240.1 | 6.6 | 5 |
| | (95) | (5) | | | | |
| Compa. | No. 18 | — | ClO₄⁻ | 260.8 | 11.5 | 3 |
| Example | (100) | | | | | |
| | No. 18 | (A) | ClO₄⁻ | 208.9 | 30.1 | 1 |
| | (95) | (5) | | | | |
| | No. 21 | — | Γ | 272.6 | 2.5 | 5 |
| | (100) | | | | | |
| | No. 21 | (A) | Γ | 210.1 | 18.5 | 3 |
| | (95) | (5) | | | | |
| | No. 22 | — | BF₄⁻ | 273.8 | 12.7 | 3 |
| | (100) | | | | | |
| | No. 22 | (A) | BF₄⁻ | 216.4 | 36.2 | 1 |
| | (95) | (5) | | | | |

### Example 4 and Comparative Example 4

Preparation of Optical Recording Medium:

The dye and the ferrocene compound shown in Table 4 below were dissolved in tetrafluoropropanol in a total concentration of 1%. The solution was applied to a 40-mm side square plate of glass by spin coating at 1000 rpm for 30 seconds and dried at 60° C. for 30 minutes to prepare a test piece of the optical recording medium.

Evaluation of Light Resistance:

The test piece was irradiated with light of 50,000 lux in a xenon weatherometer (“Table Sun” supplied by Suga Shikenki K. K.) to measure the absorbance half-life at the maximum absorption wavelength λₘₐₓ (the time required for the test piece to reduce its absorbance at λₘₐₓ to half that before exposure). The results obtained are shown in Table 4. The figures given in Table 4 as “Effect of Addition” are the differences between the absorbance half-life of a test piece comprising a dye and an additive (the ferrocene compound of the present invention or comparative compound (A)) and that of a test piece having the same dye but contains no additive.

TABLE 4

| | | Ferrocene | | |
|---|---|---|---|---|
| | Dye | Compound | Anion | Absorbance Half-life (hr) |
| | (part) | (part) | Species | (Effect of Addition) |
| Example 4 | No. 15 | No. 9 | ClO₄⁻ | 87.5 |
| | (95) | (5) | | (+48.0) |
| | No. 17 | No. 9 | ClO₄⁻ | 46.0 |
| | (95) | (5) | | (+18.5) |
| | No. 21 | No. 9 | ClO₄⁻ | 89.5 |
| | (95) | (5) | | (+48.5) |
| | No. 22 | No. 9 | ClO₄⁻ | 88.5 |
| | (95) | (5) | | (+50.0) |
| | No. 18 | No. 10 | PF₆⁻ | 45.0 |
| | (95) | (5) | | (+18.0) |
| | No. 21 | No. 13 | Γ | 108.5 |
| | (95) | (5) | | (+47.5) |
| | No. 22 | No. 14 | BF₄⁻ | 88.5 |
| | (95) | (5) | | |
| Compa. | No. 15 | — | ClO₄⁻ | 39.5 |
| Example 4 | (100) | | | (−) |
| | No. 15 | (A) | ClO₄⁻ | 71.0 |
| | (95) | (5) | | (+31.5) |
| | No. 17 | — | ClO₄⁻ | 27.5 |
| | (100) | | | (−) |
| | No. 17 | (A) | ClO₄⁻ | 28.5 |
| | (95) | (5) | | (+1.0) |
| | No. 21 | — | ClO₄⁻ | 41.0 |
| | (100) | | | (−) |
| | No. 21 | (A) | ClO₄⁻ | 68.0 |
| | (95) | (5) | | (+27.0) |
| | No. 22 | — | ClO₄⁻ | 38.5 |
| | (100) | | | (−) |
| | No. 22 | (A) | ClO₄⁻ | 69.0 |
| | (95) | (5) | | (+30.5) |
| | No. 18 | — | PF₆⁻ | 27.0 |
| | (100) | | | (−) |
| | No. 18 | (A) | PF₆⁻ | 28.5 |
| | (95) | (5) | | (+1.5) |
| | No. 21 | — | Γ | 61.0 |
| | (100) | | | (−) |
| | No. 21 | (A) | Γ | 88.5 |
| | (95) | (5) | | (+27.5) |
| | No. 22 | — | BF₄⁻ | 38.5 |
| | (100) | | | (−) |
| | No. 22 | (A) | BF₄⁻ | 70.0 |
| | (95) | (5) | | (+31.5) |

What is claimed is:

1. An optical recording medium comprising a substrate having formed thereon a thin film comprising an organic compound dye that can form pits when irradiated with a semiconductor laser beam and a compound represented by formula (I) as a recording layer: 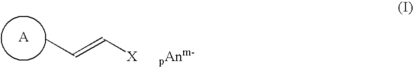
wherein X represents a metallocene group; ring A represents a heterocyclic group selected from the group consisting of: 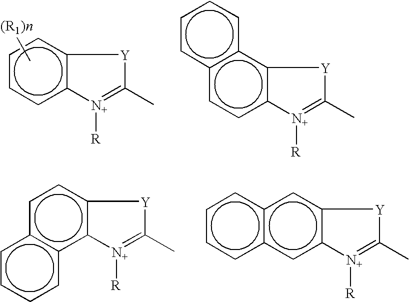
wherein n represents an integer of 0 to 2; R represents an organic group having 1 to 30 carbon atoms; R₁ represents a hydrogen atom, a halogen atom, a nitro group, a cyano group, an alkyl group having 1 to 4 carbon atoms, an alkoxy group having 1 to 4 carbon atoms, or an aryl group having 6 to 30 carbon atoms; Y represents an alkylidene group having 1 to 6 carbon atoms, or a cycloalkylidene group having 3 to 6 carbon atoms, with the metallocene group X bonded to the 2-position thereof; An^{m-} represents an m-valent anion; m represents 1 or 2; and p represents a coefficient for maintaining the charges neutral.

2. An optical recording medium according to claim 1, wherein X is a group represented by the following formula: 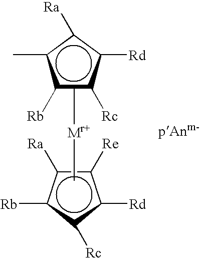
wherein Rₐ, R_{b}, R_{c}, R_{d}, and Rₑ each represent a hydrogen atom or an alkyl group having 1 to 4 carbon atoms; M represents a metal atom; An^{m-} represents an m-valent anion, which may be the same as or different from the An^{m-} in formula (I); r represents 0 or 1; m represents 1 or 2; and p′ represents a coefficient for maintaining the charges neutral.

3. An optical recording medium according to claim 1, wherein said compound represented by (I) is a compound represented by formula (II): 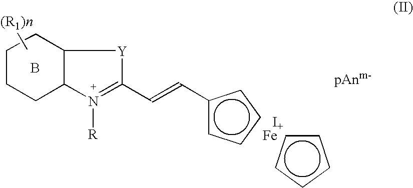
wherein ring B represents a benzene ring or a naphthalene ring; R represents an organic group having 1 to 30 carbon atoms; R₁ represents a hydrogen atom, a halogen atom, a nitro group, a cyano group, an alkyl group having 1 to 4 carbon atoms, or an alkoxy group having 1 to 4 carbon atoms; n represents an integer of 0 to 2 when ring B is a benzene ring, or n represents 0 when ring B is a naphthalene ring; Y represents an alkylidene group having 1 to 6 carbon atoms, or a cycloalkylidene group having 3 to 6 carbon atoms; 1 represents the valence of the ferrocene group, being 0 or 1; An^{m-} represents an m-valent anion; m represents 1 or 2; and p represents a coefficient for maintaining the charges neutral.

4. An optical recording medium according to claim 1, wherein Y is an alkylidene group having 1 to 6 carbon atoms or a cycloalkylidene group having 3 to 6 carbon atoms, and R is a group having formula (III):
R₃—(O)_{q}—R₂— (III)
wherein q represents 0 or 1; R₂ represents an alkylene group having 1 to 4 carbon atoms; and R₃ represents a hydrogen atom, an alkyl group having 1 to 4 carbon atoms, an alkenyl group having 2 to 4 carbon atoms, a phenyl group, or a phenyl group having one or two substituents selected from a halogen atom, an alkyl group having 1 to 4 carbon atoms, and an alkoxy group having 1 to 4 carbon atoms.

5. An optical recording medium according to claim 1, wherein said dye is at least one dye selected from an azo dye, a phthalocyanine dye, and a cyanine dye.

6. An optical recording medium according to claim 2, wherein said dye is at least one dye selected from an azo dye, a phthalocyanine dye, and a cyanine dye.

7. An optical recording medium according to claim 3, wherein said dye is at least one dye selected from an azo dye, a phthalocyanine dye, and a cyanine dye.

8. An optical recording medium according to claim 4, wherein said dye is at least one dye selected from an azo dye, a phthalocyanine dye, and a cyanine dye.

9. An optical recording medium according to claim 1, wherein said dye has the following formula:

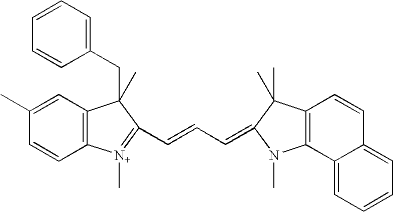

10. An optical recording medium according to claim 1, wherein said dye has the following formula:

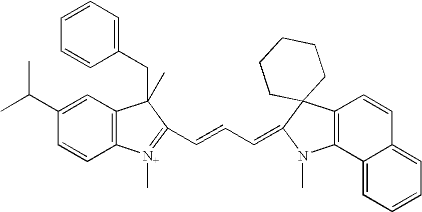

11. An optical recording medium according to claim 1, wherein said dye has the following formula:

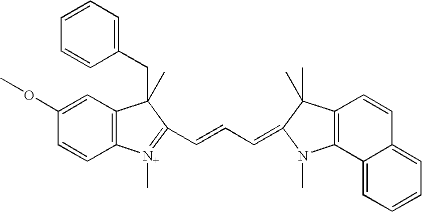

12. The optical recording medium wherein said An^{m-}is diphenylamine-4-sulfonate.
